(19) United States
(12) Patent Application Publication
(10) Pub. No.: US 2009/0014922 A1
(43) Pub. Date: Jan. 15, 2009

(54) Method and Mold Structure for Forming Eva

(76) Inventor: Lawrence Chou, Dali City (TW)

Correspondence Address: Dr. BANGER SHIA, 102 Lindencrest Ct., Sugar Land, TX, 77479-5201, US

(21) Appl. No.: 11/778,025

(22) Filed: Jul. 14, 2007

(51) Int. Cl. B29C 45/16

(52) U.S. Cl. 264/510; 425/343

(57) ABSTRACT

A method for forming EVA comprises the steps of: injection-molding; mold-exchanging; thermosetting molding; product-taking out and mold-returning. An EVA-forming mold structure comprises a first mold assembly and a second mold assembly. The molds, at the same side of the first mold assembly and the second mold assembly, can be exchanged with each other. By such arrangements, after the two material members each with different material characteristics are, respectively, formed in two mold assemblies by injection molding, a thermosetting molding of the two material members will be performed in another mold assembly, thus forming an EVA product with two material characteristics.

### BACKGROUND OF THE INVENTION

1. Field of the Invention

The present invention relates to a method and a mold structure for forming EVA, and more particularly to a method and a mold structure for forming an EVA product with two material characteristics.

2. Description of the Prior Art

EVA (ethylene vinyl acetate) is generally applied to sports and causal products (such as handles, protection tools and soles of the sports shoes and casual shoes etc), medical equipments (such as decompression cushions, prosthetic sockets and corrective cushions etc), sports equipments (such as floating boards, protection equipments and anti-impact equipments etc) and the general industrial products (such as tires and fenders etc) etc.

However, in a conventional process of forming an EVA product, the EVA product only has one material characteristic. If want to produce an EVA product with two material characteristics, it should use two different molds to form two products each with a single material characteristic, then the two material products are combined to obtain an EVA product with two material characteristics. It is equal to performing two forming processes, so it is quite inconvenient. If an EVA product with two different characteristics can be obtained in one forming process, it will not only save the forming time, but also improve the competitiveness in the industry.

Researching on forming an EVA product with two material characteristics in one forming process, the applicant of the present invention has developed an EVA forming method and mold structure.

The present invention has arisen to mitigate and/or obviate the afore-described disadvantages.

### SUMMARY OF THE INVENTION

The primary objective of the present invention is to provide a method for forming an EVA product with two material characteristics in a single manufacturing process.

The second objective of the present invention is to provide a mold structure for forming an EVA product with two material characteristics in a single manufacturing process, by exchanging the molds at the same side of a first mold assembly and a second mold assembly.

The method for forming EVA of the present invention comprises the steps of: A. injection-molding; B. mold-exchanging; C. thermosetting-molding; and D. product-taking out and mold-returning; wherein:

A. injection-molding: forming two material members with different material characteristics, respectively, in an upper mold of a first mold assembly and a lower mold of a second mold assembly by injection molding;

B. mold-exchanging: exchanging the molds at the same side of the first mold assembly and the second mold assembly, so as to enable the material member of the upper mold of the first mold assembly to be positioned against the material member of the lower mold of the second mold assembly;

C. thermosetting-molding: heating the two material members, so that the two material members are melted and connected to each other and then solidified into an EVA product; and

D. product-taking out and mold-returning: taking the EVA product out and returning the two molds to their original positions by exchanging the molds at the same side of the first mold assembly and the second mold assembly again.

The mold structure of the present invention comprises a first mold assembly and a second mold assembly. The first mold assembly includes a first upper mold with a first cavity and a first lower mold. The second mold assembly includes a second upper mold and a second lower mold with a second cavity. The molds at the same side of the first mold assembly and the second mold assembly can be exchanged.

As known from the abovementioned description, the method of the present invention not only can be used to form an EVA product with two material characteristics in a single manufacturing process, but also can be used to save manufacturing time.

### BRIEF DESCRIPTION OF THE DRAWINGS

FIG. 1 is a perspective view of a mold structure in accordance with the present invention;

FIG. 2 shows that a first material member and a second material member are being formed in accordance with the prevent invention;

FIG. 3 shows that two upper molds of two mold assemblies are being exchanged in accordance with the prevent invention;

FIG. 4 shows that an EVA product is formed by thermosetting-molding in accordance with the prevent invention;

FIG. 5 shows that the EVA product is being taken out and the upper molds of the two mold assemblies are being returned to their original positions in accordance with the present invention;

FIG. 6 shows that the upper molds of the two mold assemblies have been returned to their original positions in accordance with the present invention;

FIG. 7 is a flow chart of a method for forming EVA in accordance with the present invention; and

FIG. 8 shows that material members each with a single material characteristic are formed by the mold assemblies in accordance with the present invention.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

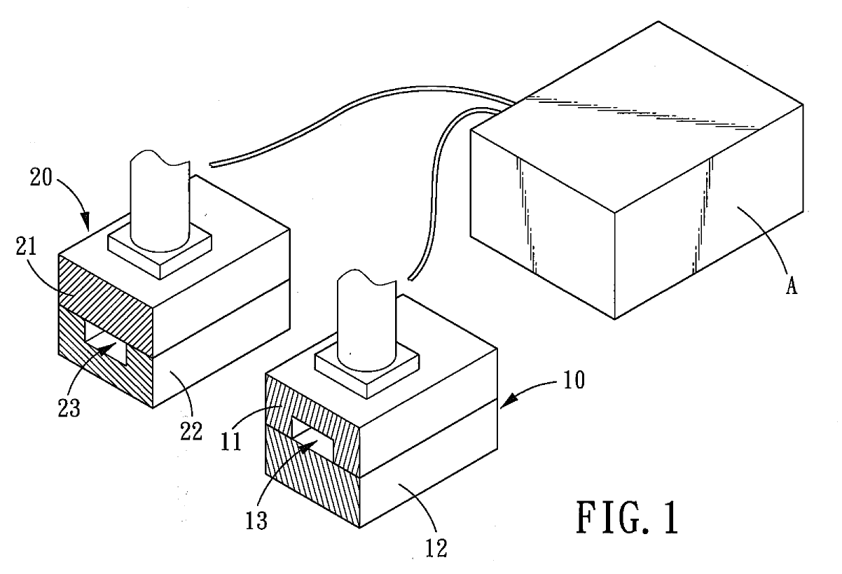

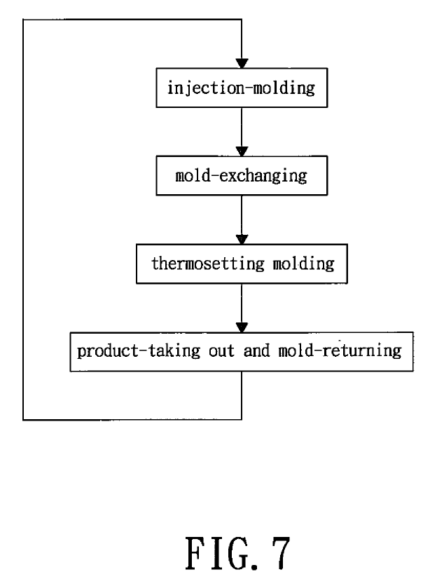

Referring to FIGS. 1-7, a method for forming EVA in accordance with a preferred embodiment of the present invention comprises four steps and cooperates with a first mold assembly 10 and a second mold assembly 20 which are shown in FIG. 1. The first mold assembly 10 includes a first upper mold 11 with a first cavity 13 and a first lower mold 12. The second mold assembly 20 includes a second upper mold 21 and a second lower mold 22 with a second cavity 23. The first mold assembly 10 and the second mold assembly 20 are, respectively, connected to and driven by a driving device A. The driving device A can adopts hydraulic pressure, air pressure, linkage bar, guideway methods or a combination of abovementioned methods to drive the first mold assembly 10 and the second mold assembly 20. Because the technology of the driving device A is well-known in the industry, the related description of the driving device is omitted here. The four steps of the method for forming EVA of the present invention are as follows:

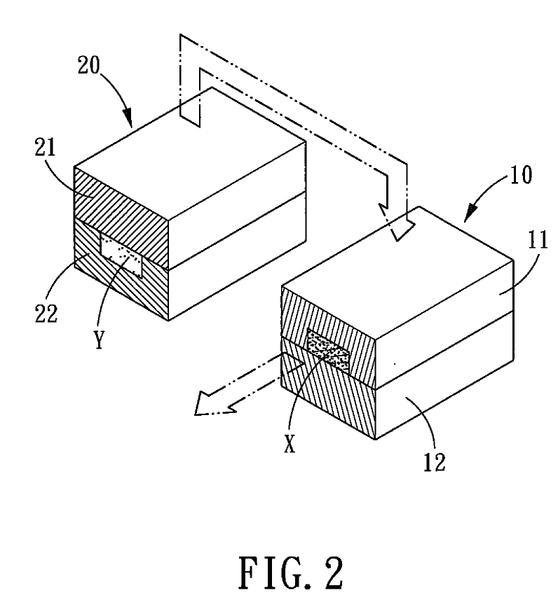

A. injection-molding: forming a first material member X with a single material characteristic and a second material member Y with a single material characteristic in the first cavity 13 of the first mold assembly 10 and the second cavity 23 of the second mold assembly 20, respectively, by injection molding, the material characteristic of the first material member X is different from that of the second material member Y, as shown in FIG. 2;

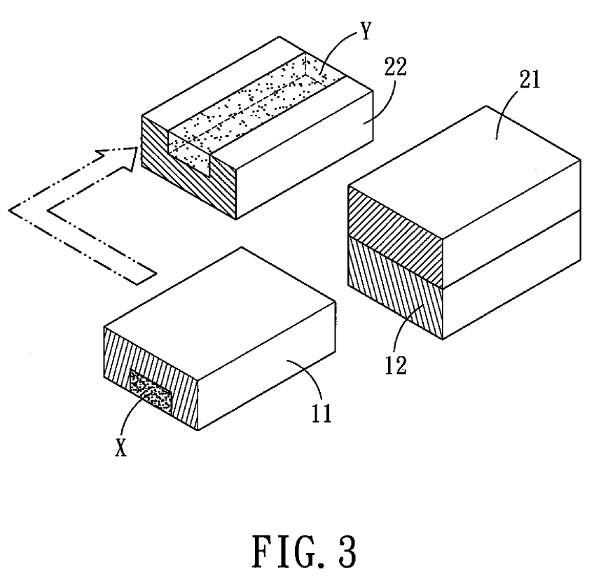

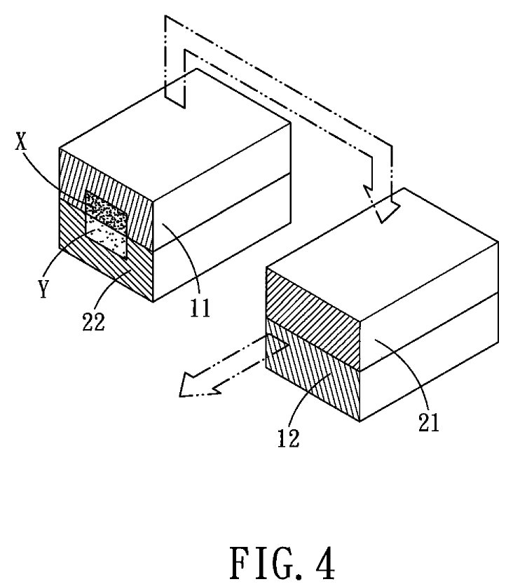

B. mold-exchanging: firstly, utilizing the driving device A to drive the first upper mold 11 to move outwards, then moving the second upper mold 21 onto the first lower mold 12 and closing the molds, as shown in FIG. 3, further referring to FIG. 4, moving the first upper mold onto the second lower mold 22 and closing the molds, so as to enable the first material member X of the first upper mold to be positioned against the second material member Y of the second lower mold 22;

C. thermosetting molding: heating the first material member X and the second material member Y, so that the first material member X and the second material member Y are melted and connected to each other and then solidified into an EVA product Z; and

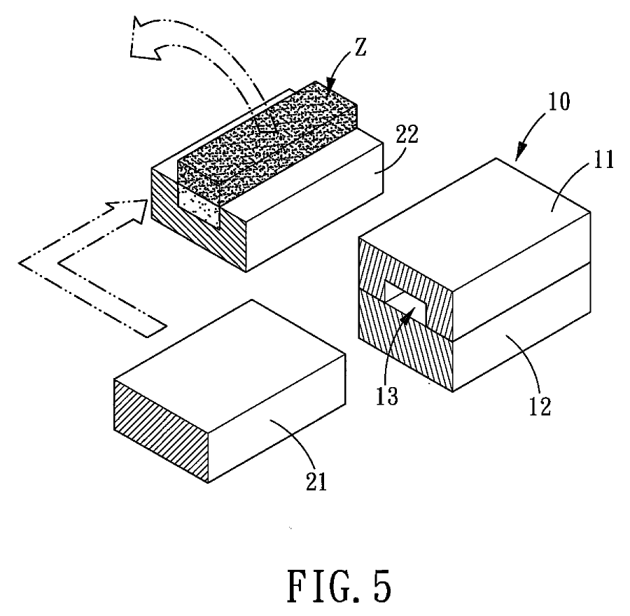

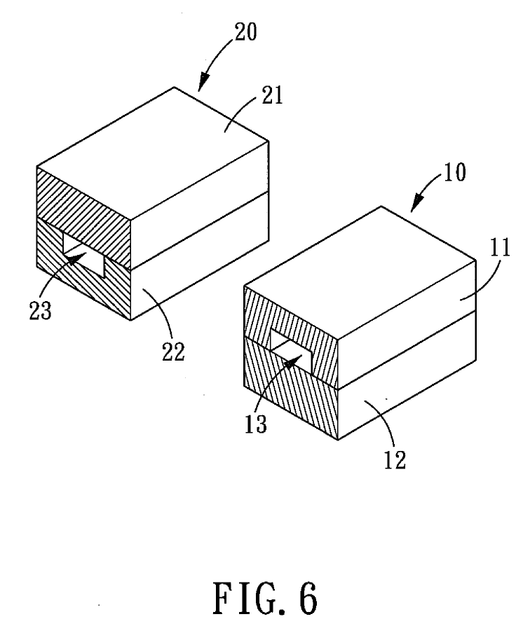

D. product-taking out and mold-returning: utilizing the driving device A to drive the second upper mold 21 to move outwards, then moving the first upper mold 11 back onto the first lower mold 12 and closing the first mold assembly 10, and at this time, taking the EVA product Z out of the second lower mold 22, as shown in FIG. 5, further as shown in FIG. 6, moving the second upper mold 21 back onto the second lower mold 22 and closing the second mold assembly 20, thus returning the first upper mold 11 of the first mold assembly 10 and the second upper mold 21 of the second mold assembly 20 to their original positions.

Additionally, the method for forming EVA of the present invention can also exchange the first lower mold 12 of the first mold assembly 10 with the second lower mold 22 of the second mold assembly 20. That is, in the mold exchanging process, moving the first lower mold 12 outwards, then moving the second lower mold 22 to a position under the first upper mold 11 and closing the molds, moving the first lower mold 12 to a position under the second upper mold 22 and closing the molds, in order to enable the first material member X of the first upper mold 11 to be positioned against the second material member Y of the second lower mold 22.

The step of product-taking out and mold-returning is to move the second lower mold 22 outwards, then move the first lower mold back to the position under the first upper mold 11 and close the molds, in order to return the first lower mold 12 of the first mold assembly 10 and the second lower mold 22 of the second mold assembly 20 back to their original positions, by such arrangements, an EVA product with two material characteristics can also formed in a single manufacturing process.

It is clear from the abovementioned description that the method for forming EVA of the present invention can be used to form an EVA product Z with the first material member X and the second material member Y through a single manufacturing process. Since it is possible to form an EVA product with two material characteristics, it can also form an EVA product with double colors and two material characteristics by using the first material member X and the second material member Y which are different in color. By such arrangements, it further saves the time of manufacturing an EVA product with two material characteristics and greatly strengthens the industrial competitiveness.

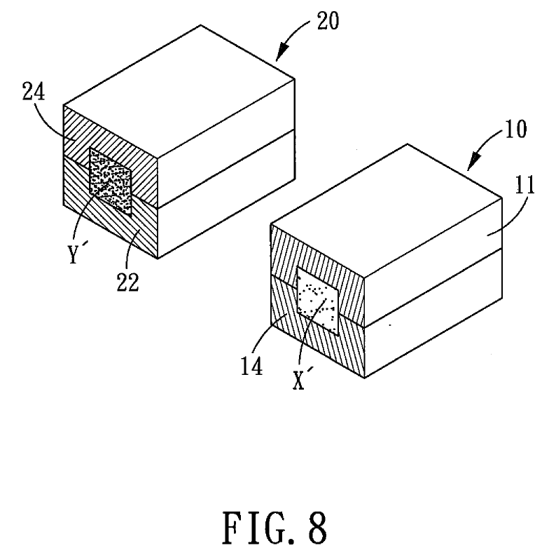

Moreover, the first mold assembly 10 and the second mold assembly 20 can not only be used to form an EVA product with two material characteristics, as shown in FIG. 8, but also be used to form a third material member X′ with a single material characteristic and a fourth material member Y′ with a single material by replacing the first lower mold 12 of the first mold assembly 10 with a lower mold 14 with a cavity and replacing the second upper mold 21 with an upper mold 24 with a cavity to use the first mold assembly 10 and the second mold assembly 20 as general molds.

To summarize, the method and mold structure for forming EVA in accordance with the present invention comprises the following four steps: A. injection-molding; B. mold-exchanging; C. thermosetting-molding; D. product-taking out and mold-returning. The mold structure for forming EVA of the present invention comprises a first mold assembly and a second mold assembly, and the same side molds of the first mold assembly and the second mold assembly can be exchanged. By such arrangements, after two material members with different material characteristics are, respectively, formed in two mold assemblies by injection molding, a thermosetting molding of the two material members will be performed in another mold assembly, thus obtaining an EVA product with two material characteristics.

While we have shown and described various embodiments in accordance with the present invention, it is clear to those skilled in the art that further embodiments may be made without departing from the scope of the present invention.

What is claimed is:

1. A method for forming EVA comprising the steps of:
A. injection-molding: forming a first material member and a second material member, respectively, in a first upper mold of a first mold assembly and a second lower mold of a second mold assembly by injection molding, and the first material member is different from the second material member in material characteristic;
B. mold-exchanging: exchanging the first upper mold of the first mold assembly with the second upper mold of the second mold assembly, closing the second upper mold of the second mold assembly and the first lower mold of the first mold assembly together, and closing the first upper mold of the first mold assembly and the second lower mold of the second mold assembly together, so as to enable the first material member of the first upper mold to be positioned against the second material member of the second lower mold;
C. thermosetting-molding: heating the first material member and the second material member, so that the first material member and the second material member are melted and connected to each other and then solidified into an EVA product; and
D. product-taking out and mold-returning: taking the EVA product out, and returning the two upper molds to their original positions by exchanging the first upper mold with the second upper mold again.

2. The method for forming EVA as claimed in claim 1, wherein the first material member in the step of the injection-molding is different from the second material member in color.

3. A mold structure for forming EVA used in the method for forming EVA as claimed in claim 1 comprising a first mold assembly and a second mold assembly, the first mold assembly including a first upper mold with a first cavity and a first lower mold, the second mold assembly including a second upper mold and a second lower mold with a second cavity, and the first mold assembly and the second mold assembly being connected to a driving device used to drive the first upper mold of the first mold assembly to exchange with the second upper mold of the second mold assembly.

4. The mold structure for forming EVA as claimed in claim 3, wherein the driving device adopts hydraulic pressure, air pressure, linkage bar, guideway methods or a combination of abovementioned methods to drive the first mold assembly and the second mold assembly.

5. A method for forming EVA comprising the steps of:
A. injection-molding: forming a first material member and a second material member, respectively, in an upper mold of a first mold assembly and a second lower mold of a second mold assembly by injection molding, and the first material member is different from the second material member in material characteristic.
B. mold-exchanging: exchanging the first lower mold of the first mold assembly with the second lower mold of the second mold assembly, and closing the second upper mold of the second mold assembly onto the first lower mold of the first mold assembly, and closing the first upper mold of the first mold assembly onto the second lower mold of the second mold, so as to enable the first material member of the first upper mold to be positioned against the second material member of the second lower mold;
C. thermosetting-molding: heating the first material member and the second material member, so that the first material member and the second material member are melted and connected to each other and then solidified into an EVA product; and
D. product-taking out and mold-returning: taking the EVA product out, and returning the two lower molds to their original positions by exchanging the first lower mold with the second lower mold again.

6. The method for forming EVA as claimed in claim 5, wherein the first material member in the step of the injection-molding is different from the second material member in color.

7. A mold structure used in the method for forming EVA as claimed in claim 5 comprising a first mold assembly and a second mold assembly, the first mold assembly including a first upper mold with a first cavity and a first lower mold, the second mold assembly including a second upper mold and a second lower mold with a second cavity, and the first mold assembly and the second mold assembly being connected with a driving device used to drive the first lower mold of the first mold assembly to exchange with the second lower mold of the second mold assembly.

8. The mold structure for forming EVA as claimed in claim 7, wherein adopts hydraulic pressure, air pressure, linkage bar, guideway methods or a combination of abovementioned methods to drive the first mold assembly and the second mold assembly.
